(19) United States
(12) Patent Application Publication
(10) Pub. No.: US 2015/0146424 A1
(43) Pub. Date: May 28, 2015

(54) LED LIGHTING DEVICE

(71) Applicant: DCG Systems, Inc., Fremont, CA (US)

(72) Inventors: Dieter Karg, Nurnberg (DE); Jochen Neumann, Furth (DE); Hans Heissenstein, Wiesenttal (DE)

(21) Appl. No.: 14/409,469

(22) PCT Filed: Jun. 21, 2013
(86) PCT No.: PCT/EP2013/063032

§ 371 Date: Dec. 19, 2014

(30) Foreign Application Priority Data
Jun. 22, 2012 (DE) 20 2012 102 312.1

(51) Int. Cl. F21V 5/00

(52) U.S. Cl. CPC F21V 5/007; F21Y 2101/02
USPC 362/240

(57) ABSTRACT

LED illuminating device, comprises a housing (2), within which an array of LED elements (26) is arranged, a plurality of lenses (28) which are associated with the LED elements (26), as well as a supporting plate (20) with openings (34) for receiving the lenses (28), wherein the openings (34) for the lenses (28) in the supporting plate (20) are arranged, at least in part, out-of-center with respect to the LED elements (26).

The invention relates to a LED illuminating device.

From the US 2011/0063840 A, a LED illuminating device is known which comprises the general arrangement of a field of lenses which serves to collect the divergent light from the individual LED elements. For this purpose, a lens is associated to each LED element. For the rest, this publication is concerned with the shape of the surface of the fens in order to put up the efficiency in focusing the light from the LED element field.

The invention is based on the objective to provide an LED illuminating device with which, in a simple and cost effective way, various illuminating patterns can be generated on a surface to be illuminated.

Examples are a uniform illumination of a larger illumination field or that the illumination yield from a LED element is focused to a spot or a small area on the plane to be illuminated.

For this purpose, the LED illuminating device of the invention comprises a housing within which an array of LED elements is arranged, a plurality of lenses which are associated with the LED elements, as well as a supporting plate with openings for receiving the lenses, wherein the openings for lenses in the supporting plate are arranged, at least in part, out-of-center with respect to the LED elements. By means of this LED illuminating device, it is achieved in an advantageous way that, by selecting the eccentricity or the out-of-center position of the lenses with respect to the LED elements, various illumination patterns can be generated thereby that the relative position between the lenses and the LED elements is adjusted accordingly.

An advantageous embodiment of the LED illuminating device according to the invention is characterized in that the LED elements are arranged in the field with equal distances to each other. Thereby, it is achieved in an advantageous way that a precise geometrical relationship between the LED elements and the supporting plate is achieved. The orientation of the plane supporting plate with respect to the LED elements is an important precondition for the precise guidance of the light rays which is required for the respective design of the illumination on the surface to be illuminated. Therefore, this arrangement is also advantageous with respect to the design of the optics.

A further advantageous embodiment of the LED illuminating device according to the invention is characterized in that the lenses each comprise a guiding projection with which they are centered in the openings of the supporting plate. Thereby, a precise relationship between the position of the LED elements and the supporting plate or the openings made therein, respectively, is achieved, wherein the lenses are arranged such that a simple and secure assembly of the supporting plate with the lenses is ensured. Therein, the lenses are always positioned centralized to the openings whereby the LED elements can be arranged out-of-center with respect to the openings.

A further advantageous embodiment of the LED illuminating device according to the invention is characterized in that the guiding projection is a cylindrical wall whereby the LED elements extend into the guiding projection also in case of an out-of-center position thereof. Thereby, the LED elements can be arranged close to the lenses, and the overall light yield of the LED elements is captured by the lens and processed thereby.

A further advantageous embodiment of the LED illuminating device according to the invention is characterized in that the openings are arranged in the supporting plate with respect to the LED elements in such positions that the light arrays emitted from the LED element's bring about a homogenous illumination of a surface to be illuminated. This is advantageous in case a deflection of the light arrays of the LED element from a perpendicular line through the middle of the field of the LED elements directed away from the perpendicular line to the outside, is larger with increasing distance from the perpendicular line. This embodiment enables, in an advantageous way, a homogenous illumination of the surface to be illuminated even when the surface to be illuminated has a larger area extend then the area extend of the LED field.

A further advantageous embodiment of the LED illuminating device according to the invention is characterized in that the openings in the supporting plate and, thereby, the lenses are located with respect to the LED elements at such positions that the light beams emitted from the LED elements are focused to a focus area of a surface to be illuminated. By this arrangement, it can be achieved in an advantageous way that a spot or a small surface area in front of the LED illuminating device may be illuminated at a higher degree as in a case of a homogenous illumination, by means of the focused beams of the individual LED elements. The arrangement according to this embodiment is particularly suited for the case where the illumination output from the LED elements is used for excitation in heat flow thermography methods.

A further advantageous embodiment of the LED illuminating device according to the invention is characterized in that the openings in the supporting plate and, thereby, the lenses are located with respect to the LED elements at such positions that the light beams emitted by a group of LED elements are focused for each group to a focus area on a surface to be illuminated. Therefore, it is not only possible to focus all light beams of the LEDs to one spot but the beams of the individual LED elements can be focused onto two or more areas of the surface to be illuminated.

A further advantageous embodiment of the LED illuminating device according to the invention is characterized in that a supporting plate with corresponding openings for receiving the lenses is associated with each illuminating mode, and that the supporting plate is fixed to the housing in an exchangeable manner. Thereby, it is achieved in an advantageous way that one and the same device can be used for a differing illumination of the surface to be illuminated, where only the plate with the lenses has to be ex-changed, in particular, when the LED elements are arranged at equal distances with each other in a homogenous field.

Therefore, the invention makes it possible to generate differing illumination patterns on the surface to be illuminated, and this done with simple means and without the necessity to have to provide a separate device for a particular illumination pattern.

Further advantages, features and potential applications of the present invention may be gathered from the description which follows, in conjunction with the embodiments illustrated in the drawings.

Throughout the description, the claims and the drawings, those terms and associated reference signs will be used as are notable from the enclosed list of reference signs. In the drawings:

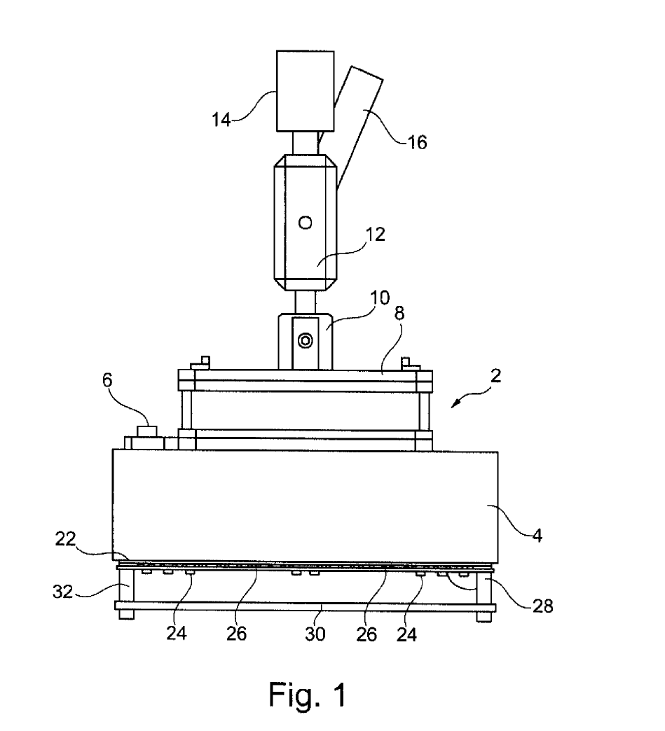

FIG. 1 is a side view of the LED illuminating device where the main components of the device are shown;

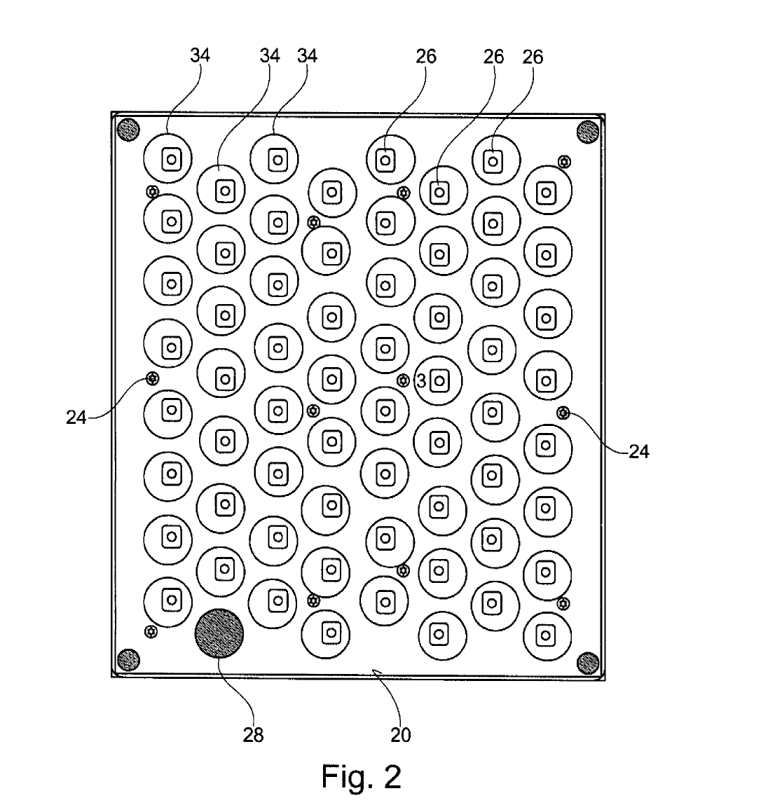

FIG. 2 is a top view onto the supporting plate where the position of the openings in the supporting plate in relation to the respective LED elements is shown;

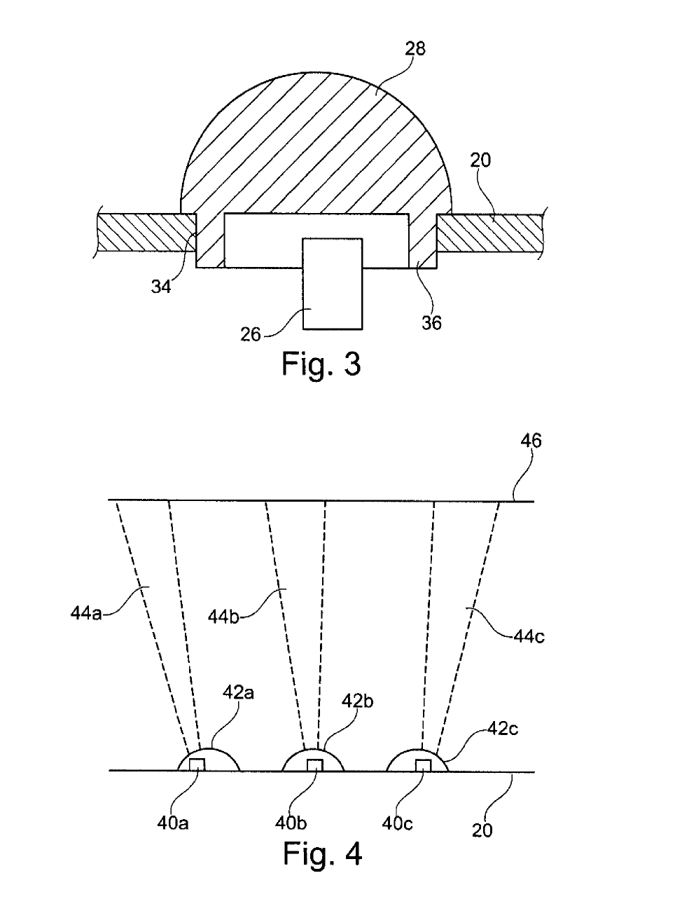

FIG. 3 is a schematic detail view of a lens and a LED element as they are arranged in the supporting plate;

FIG. 4 is a schematic view which shows how the relative position between the lenses and the LED elements is influencing the direction of the light beams emitted from the lens;

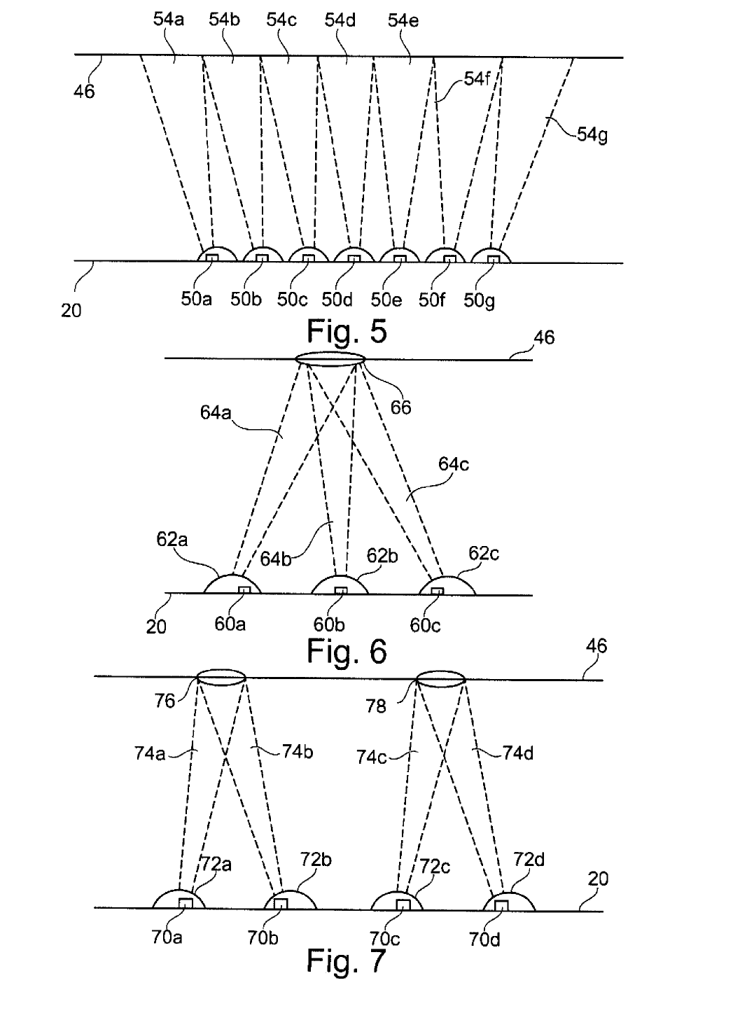

FIG. 5 is an arrangement which serves for a homogenous illumination of the surface to be illuminated;

FIG. 6 shows an arrangement which serves the purpose to focus the light beams of the individual LED elements through the associated lenses to a small focus area; and

FIG. 7 shows an arrangement by which the light beams of each two LED elements and the respective lenses are focused to a respective focus area.

FIG. 1 shows an embodiment of the LED illuminating device comprising a housing 2 having a cooling device 4, comprising cooling rips, and a current connection 6 for the current supply to the device. The housing comprises, on a back side (arranged on top in FIG. 2) holding plate 8 connected to the cooling device 4 through a base plate 10. In the housing 2, the electrical leads for the LED field are arranged. The plate 8 is connected to a socket 10 which is connected to a handle 14 through a ball joint 12.

The ball joint 12 makes it possible to arbitrarily adjust the angular position of the housing with respect to the handle. The ball joint 12 can be fixed in the position adjusted by means of a lever 16 which fixes the parts of the wall joint against rotation with respect to each other. At the outer side of the cooling device 4 (bottom side of the cooling device 4 in FIG. 1), a supporting plate 20 is shown which is mounted spaced to part from the cooling device by means of spacer pieces 22 and which is fixed by means of screws 24. In between the supporting plate 20 and the cooling device 4, the individual LED elements 26 are shown schematically. For simplification of the drawings, only one lens 28 is shown which is inserted into an opening 34 of the supporting plate 20. The other openings 34 of the supporting plate 20 are also correspondingly equipped with lenses 26.

Finally the LED device according to FIG. 1 has a protective plate 30 which is connected to the cooling device 4 by means of distance holders 32 and which is arranged in front of the optical installation comprising the LED elements 26 and the lenses 28.

FIG. 2 shows a top view of the supporting plate 20 with openings 34 for receiving the lenses 28. As can be seen from FIG. 2 the openings 34 for the lenses 28 are arranged in the supporting plate 20 at least in part out-of-center with respect to the LED elements 26 whereas the LED elements 26 themselves are arranged in a regular pattern with respect to one another in the field.

As can be seen in FIG. 3 in detail, the lenses 28 in the supporting plate 20 are supported thereby that the lenses 28 each comprise, in this example circular guiding projection 36 by which they are centered in, in this example round, openings 34 of the supporting plate 20. The openings 34 and the guiding projections 36 can also have another shape but the round shape. As is shown in FIG. 3, the LED elements 26 are arranged with equal distances with respect to each other in the field. The LED element 26 which is schematically shown in FIG. 3, is arranged out-of-center with respect to the center line of the lens 28. Furthermore, the guiding projection 36 is a cylindrical wall where the LED 26 extends also in an out-of-center position thereof into the guiding projection as sufficient space is provided for the LED element from the guiding projection 36 or the wall, respectively.

FIG. 4 shows the principle according to which the light arrays output from the LED elements 40a to 40c through the lenses 42a to 42c are deflected in such a direction that the desired illumination pattern is generated on the surface to be illuminated. For this purpose, three LED elements 40a, 40b, 40c are shown which are associated each to the corresponding lenses 42a, 42b, 42c. The combination of the LED element 40a with the lens 42a has the effect that the light beam 44a emitted from this combination is deflected from the center line of the arrangement to the outside (left hand side in FIG. 4) with respect to the center line, which is achieved thereby that the LED element 40a is displaced with respect to the center line of the lens 42a to the left. The combination of the LED element 40b with the lens 42b results in a light beam 44b running perpendicular to the plane of the supporting plate 20 because the LED element 40b is mounted centrally below the lens 42b. Accordingly, a light beam 44c of the combination of the LED element 40c with the lens 42c is deflected with respect to the center line of the arrangement to the outside (to the right in FIG. 4) which is achieved thereby that the LED element 40c is displaced with respect to the center of the lens 42c to the right.

FIG. 5 shows an embodiment of the illumination of the surface 46 to be illuminated in which a constantly homogenous illumination of the surface 46 to be illuminated is achieved in that, with respect to a vertical line through the center of the field of the LED elements 50a to 50g, the light rays Ma to 54g are deflected from the center line of the LED field away to the outside is increasing with increasing distance from the vertical line. This is achieved through the respective out-of-center position of the LED elements 50a to 50c and 50e to 50g with respect to the respective lenses 52a to 52c and 52e to 52g.

FIG. 6 shows an embodiment in which the openings in the supporting plate 20 are located with respect to the LED elements 60a to 60c in such positions that the light rays 64a, 64b, 64c emitted from the LED elements 60a to 60c are focused onto a focusing area 66 on the surface 46 to be illuminated. This is achieved thereby that the LED elements 60a and 60c are displaced with respect to the center of the respective lenses 62a and 62c each in the direction of the center LED element 60b.

FIG. 7 shows an embodiment in which the openings in the supporting plate 20 are located in such positions with respect to the LED element 70a to 70d that the light rays 74a, 74b and 74c, 74d respectively, emitted from the LED elements 70a, 70b and 70c, 70d respectively, are focused by means of the lenses 72a to 72d onto a focus area 76 and 78, respectively per group on a surface 20 to be illuminated.

Since the supporting plate 20 is exchangeable fixed to the housing 2 and the cooling device 4, respectively, the LED illuminating device as a whole can be exchanged quite easily from one application to another thereby that only the supporting plate 20 is exchanged.

The invention is not limited to the embodiments shown. Rather, it is apparent for the skilled person that arbitrary illumination patterns can be generated on the surface 46 to be illuminated thereby that the light rays output by the combinations of LED elements and lenses are adapted correspondingly with respect to the vertical line through the supporting plate or the LED field respectively.

### LIST OF REFERENCE SIGNS

2 Housing

4 Cooling device

6 Current connection

8 Holding plate

10 Socket

12 Ball joint

14 Handle

16 Lever

20 Supporting plate

22 Spacer piece

24 Screws

26 LED elements

28 Lens

30 Protective plate

32 Distance holder

34 Openings

36 Guiding projection

40a-40c LED elements

42a-42c Lenses

46a-46g Light rays

50a-50g LED elements

52a-52g Lenses

54a-54g Light rays

60a-60c LED elements

62a-62c Lenses

64a-64c Light rays

66 Focus area

70a-70d LED elements

72a-72d Lenses

74a-74d Light rays

76 Focus area

78 Focus area

1. LED illuminating device, comprising:
a housing (2), within which an array of LED elements (26) is arranged,
a plurality of lenses (28) which are associated with the LED elements (26), as well as a supporting plate (20) with openings (34) for receiving the lenses (28), wherein the openings (34) for the lenses (28) in the supporting plate (20) are arranged, at least in part,
out-of-center with respect to the LED elements (26).

2. LED illuminating device according to claim 1, characterized in that the LED elements (26) are arranged perpendicularly to the plane supporting plate (20).

3. LED illuminating device according to claim 1 or 2, characterized in that the lenses (28) each comprise a guiding projection (36) within which they are centered in the openings (34) of the supporting plate (20).

4. LED illuminating device according to claim 3, characterized in that the guiding projection (36) is a cylindrical wall whereby the LED elements (26) extend into the guiding projection (36) also in case of an out-of-center-position thereof.

5. LED illuminating device according to one of the claims 1 to 4, characterized in that the openings (34) are arranged in the supporting plate (20) with respect to the LED elements (26) in such positions that the light arrays emitted from the LED elements (26) effect a homogenous illumination of a surface (46) to be illuminated.

6. LED illuminating device according to claim 5, characterized in that a deflection of the light beams of the LED elements (26) which deflection is with respect to a vertical line through the center of the LED array directed away from the vertical line to the outside and is becoming larger with the increasing distance from the vertical line.

7. LED illuminating device according to one of the claims 1 to 4, characterized in that the openings (34) in the supporting plate (20) and, thereby, the lenses are located with respect to the LED elements at such positions that the light beams emitted from the LED elements are focused to a focus area (66) of a surface (46) to be illuminated.

8. LED illuminating device according to any of the claims 1 to 4, characterized in that the openings (34) in the supporting plate (20) and, thereby, the lenses are located with respect to the LED elements at such positions that light beams emitted by a group of LED elements are focused for each group to a focus area (76, 78) on a surface (46) to be illuminated.

9. LED illuminating device according to claim 1, characterized in that a supporting plate (20) with corresponding openings (34) for receiving the lenses (28) is associated with each illuminating mode, and that the supporting plate (20) is fixed to the housing (2) in an exchangeable manner.
